(19) United States
(12) Patent Application Publication
(10) Pub. No.: US 2025/0033542 A1
(43) Pub. Date: Jan. 30, 2025

(54) VENTILATED CUSHION FOR VEHICLE SEATS

(71) Applicant: Zhejiang Tianhong Auto Products Co., Ltd., Taizhou (CN)

(72) Inventor: Tongchai Chen, Taizhou (CN)

(21) Appl. No.: 18/911,097

(22) Filed: Oct. 9, 2024

Related U.S. Application Data
(63) Continuation of application No. PCT/CN2023/080639, filed on Mar. 9, 2023.

(30) Foreign Application Priority Data
Dec. 5, 2022 (CN) 202223269440.6

(51) Int. Cl. B60N 2/56

(52) U.S. Cl. CPC B60N 2/5642; B60N 2/5657

(57) ABSTRACT

A ventilation cushion for vehicle seats is provided, which is provided with a plurality of ventilation holes on a cushion body. A back of the cushion body located in an area of the ventilation holes is provided with a fan installation position. The cushion body includes an edge portion and a body upper portion, a body middle portion, and a body lower portion that are arranged in sequence from top to bottom. The body upper portion, the body middle portion, and the body lower portion are all located in an area that is surrounded by the edge portion. A back of the body lower portion is provided with at least one support protrusion, and the fan installation position is located on a back of the body middle portion and close to the body lower portion. The present application greatly improves a problem of reduced air output and obstructed air flow.

### CROSS-REFERENCE TO RELATED APPLICATIONS

This application is a continuation of International Application No. PCT/CN2023/080639, filed on Mar. 9, 2023, which claims priority to Chinese Patent Application No. 202223269440.6, filed on Dec. 5, 2022, both of which are hereby incorporated by reference in their entireties.

### TECHNICAL FIELD

The present disclosure relates to the field of vehicle seat cushion technologies, and in particular, to a ventilated cushion for vehicle seats.

### BACKGROUND

Vehicles are a common and frequently used means of transportation in today's era. With the gradual development of the times and the continuous improvement of people's daily living standards, there are increasingly more requirements for driving comfort of vehicles. Not only the vehicles need to have high maneuverability but need better comfort.

During a production process of the vehicles, it is necessary to adjust them according to a usage environment of each vehicle model. If there is a preference for comfort tuning, the handling of the vehicle will be partially sacrificed, and vice versa. Especially for SUV and off-road vehicle tuning, there will be relatively more sacrifices in comfort.

For drivers and passengers, vehicle seats are the main source of comfort, so there are many seat cushions and back cushion used for vehicle seats. The back cushions are commonly seen in daily life, such as breathable cushions. In hot summer, drivers and passengers are prone to sweating inside the vehicle, especially on the back, which can seriously affect comfort due to sweating. This breathable cushion can improve breathability to a certain extent, rendering the comfort of the drivers and passengers better. A ventilation cushion for vehicle seats disclosed in CN203211145U, including a cushion cover and a plug with a speed control device. The cushion cover is equipped with a cushion body and a cushion front plate, fan installation compartments are installed on both sides of a front lower end of the cushion body, and a turbofan is installed inside the fan installation compartments; there are air outlet ducts around the fan installation compartments; the cushion front plate is set at a front end of the cushion body, and an air outlet is set on the cushion front plate corresponding to an air outlet groove.

Regarding the relevant technologies mentioned above, it is believed that although the ventilation cushion can play a role of ventilation, prolonged sitting can also lead to poor ventilation. The main reason is that during driving, the cushion is subjected to significant backward pressure, which can cause the cushion to shift due to the vehicle's bumps and a constant adjustment of a sitting posture by the driver and passengers. Furthermore, due to prolonged sitting by the driver and passengers, the fan is located too close to the seat and backs of the driver and passengers, which results in reduced air flow and even causes the fan to be blocked and easily burned out.

### SUMMARY

In order to improve the problem of the cushion being leaned back by the driver and passengers for a long time, thereby causing the fan position to be too close to the seat and backs of the driver and passengers, thereby resulting in a decrease in air flow, and even causing the fan to burn out due to airflow obstruction, the present application provides a ventilation cushion for vehicle seats.

The present application provides the ventilation cushion for vehicle seats, which adopts the following technical solution.

A ventilated cushion for vehicle seats, including a cushion body, which is provided with a plurality of ventilation holes, a back of the cushion body that is located in an area of the ventilation holes is provided with a fan installation position; the cushion body includes an edge portion and a body upper portion, a body middle portion, and a body lower portion arranged in sequence from top to bottom; the body upper portion, the body middle portion, and the body lower portion are all located in an area surrounded by the edge portion; a back of the body lower portion is provided with at least one support protrusion, and the fan installation position is located on a back of the body middle portion and close to the body lower portion.

In some embodiments of the present disclosure, the body upper portion and the body lower portion both are faced towards the body middle portion and tilted towards a front of the cushion body; the body middle portion is bent from its upper and lower ends towards a middle and towards the front of the cushion body.

In some embodiments of the present disclosure, the body upper portion, the body middle portion, and the body lower portion are all provided with arc-shaped transition surfaces on left and right sides from a middle.

In some embodiments of the present disclosure, the edge portions provided on left and right sides of the body middle portion are bent towards the front of the cushion body to form an arc-shaped support edge.

In some embodiments of the present disclosure, a front of the edge portion is higher than fronts of the body upper portion, the body middle portion, and the body lower portion, the edge portion is provided with transition sections at left and right sides of the body lower portion; a front of the transition section is inclined towards the back of the cushion body to form a connection between the front of the transition section and the front of the body lower portion.

In some embodiments of the present disclosure, a front of the cushion body is longitudinally provided with a plurality of guide grooves, the guide grooves are all extended from lowers of the body lower portion and/or the body middle portion to the edge portions of uppers of the body upper portion and/or the body middle portion.

In some embodiments of the present disclosure, the back of the cushion body and a corresponding position of each guide groove are protruded towards the back of the cushion body to form a reinforcing rib, the reinforcing ribs are all extended from lowers of the body lower portion and/or the body middle portion to uppers of the body upper portion and/or the body middle portion, one end of the reinforcing rib located at the uppers of the body upper portion and/or the body middle portion is not connected to the edge portion; the fan installation position is provided on the reinforcing rib on a lower of the body middle portion.

In some embodiments of the present disclosure, a recess is provided at a front of the body lower portion and a corresponding position of the support protrusion.

In some embodiments of the present disclosure, a lower of the cushion body is connected to an elastic support member that is inclined downward towards a rear direction, and the elastic support member is connected to the lower of the cushion body through an arc-shaped transition connection member.

In some embodiments of the present disclosure, left and right edges of the elastic support member are gradually contract and tilt towards a middle from the rear direction.

In summary, the present application includes at least one beneficial technical effect as follows.
1. The support protrusions are provided to render a large ventilation space is formed between a back of the cushion body and a seat, this ventilation space can still ensure sufficient ventilation even without installing a fan, especially when the cushion is compressed by the driver or passenger when leaning on, a convection effect of air through the ventilation holes will be stronger; and a fan installation position is provided near the support protrusion, so that even when the driver and passenger are leaning back, the fan installation position will not be too close to the seat and the back of the driver and passenger, thereby greatly improving a problem of reduced air flow and obstructed air flow, rendering the ventilation effect stronger, more significant and better.
2. By providing with an inclined structure and arc-shaped transition surface on the body upper portion, the body middle portion, and the body lower portion, it can effectively support the waist and back of the driver and passenger during use, and improve air output and flow rate.
3. By providing with a support edge, a riding experience of driver and passenger can be greatly improved. Whether driving or resting in the vehicle, it can provide a certain degree of support for the waist on two sides of the driver and passenger.
4. By providing with a guide groove, the air can be better diffused towards an edge after being obstructed, thereby effectively improving a ventilation effect without affecting the air output and flow rate.
5. By providing with a reinforcing rib, a support strength can be effectively improved, which will not cause serious deformation of the cushion due to long-term leaning back. This greatly ensures a normal operation of the fan and also avoids a situation of the fan being damaged by compression to a certain extent.
6. By providing with a recess at a front of the body lower portion and a corresponding position of the supporting protrusion, air can be better diffused towards the edge after being obstructed, thereby effectively improving the ventilation effect.
7. By providing with an elastic support, it is possible to avoid a problem of a cushion displacement caused by adjusting a sitting posture during long-term reclining. Besides that, the elastic support can also assist in reducing a problem of the fan position being squeezed by a reclining force, thereby greatly improving a reliability of the cushion during use.

### BRIEF DESCRIPTION OF DRAWINGS

FIG. 1 is a front schematic structural diagram provided by an embodiment of the present application.

FIG. 2 is a back schematic structural diagram provided by an embodiment of the present application.

FIG. 3 is a partially enlarged schematic diagram of part A in FIG. 1.

### NUMERAL REFERENCE

1—ventilation hole; 2—fan installation position; 3—edge portion; 4—support edge; 5—transition section; 6—support protrusion; 7—recess; 8—guide groove; 9—reinforcing rib; 10—elastic support member; 11—transition connection member.

### DESCRIPTION OF EMBODIMENTS

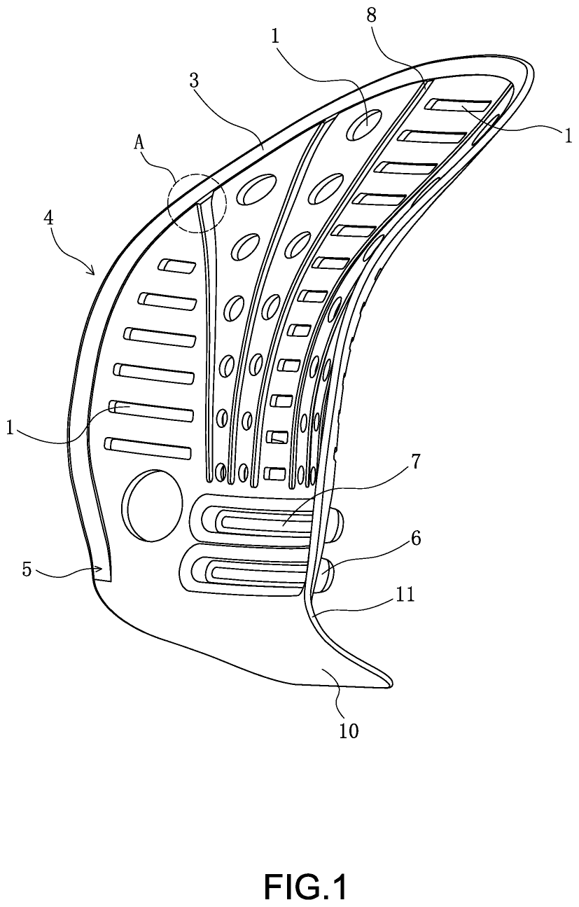

Further detailed explanation of the present application will be provided in combination with FIGS. 1-3.

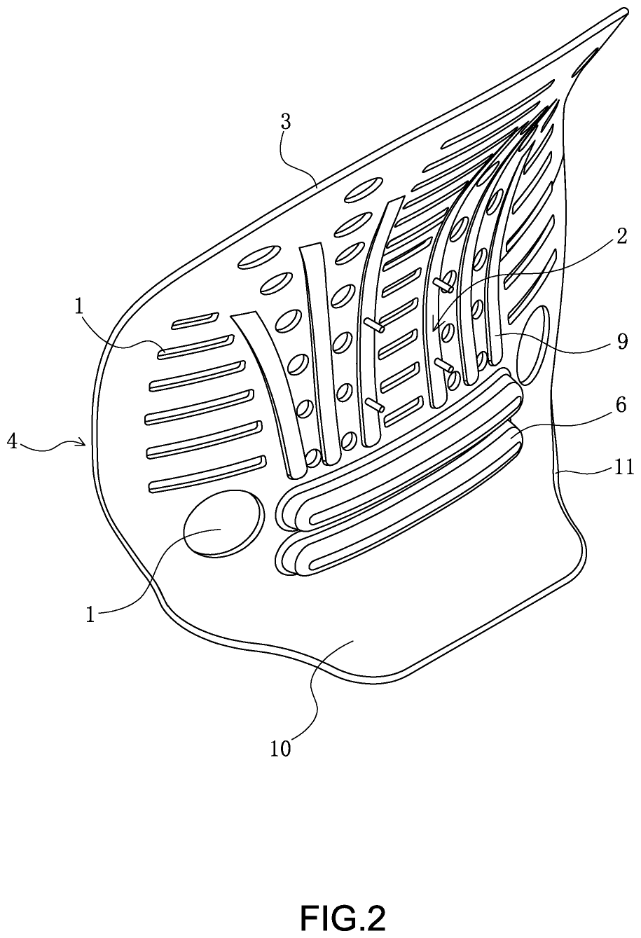

This embodiment discloses a ventilation cushion for automobile seats. Referring to FIGS. 1 and 2, the cushion body is provided with a plurality of ventilation holes 1. A back of the cushion body that is located in an area of the ventilation holes 1 is provided with a fan installation position 2. The cushion body includes an edge portion 3 and a body upper portion, a body middle portion, and a body lower portion that are arranged from top to bottom. The edge portion 3 surrounds an area with an open at a lower side, and the body upper portion, the body middle portion, and the body lower portion are all located in an area surrounded by the edge portion 3.

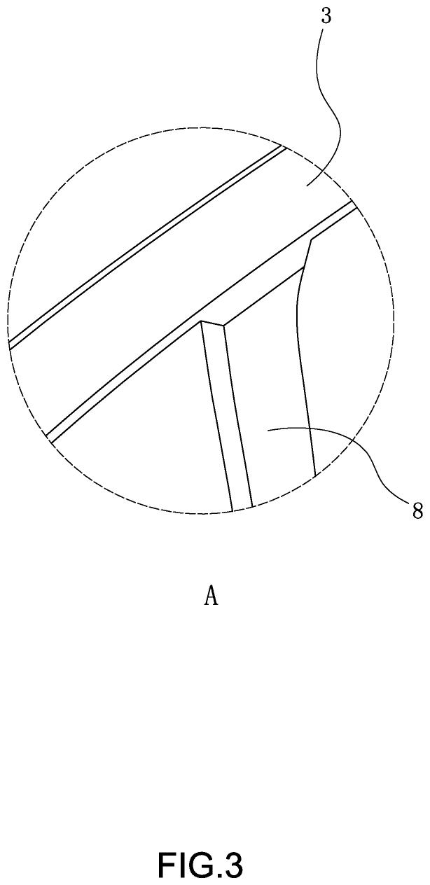

In this embodiment, the edge portions 3 located on left and right sides of the body middle portion are bent towards a front of the cushion body to form an arc-shaped support edge 4. Referring to FIG. 3, a front of the edge portion 3 is higher than fronts of the body upper portion, the body middle portion, and the body lower portion, thereby forming a stepped structure between the edge portion 3 and the body upper portion, the body middle portion, and the body lower portion. This enhances a ventilation effect and renders the air flow smoother; the edge portion 3 is provided with transition sections 5 located at left and right sides of the body lower portion. A front of the transition section 5 is inclined towards the back of the cushion body to form a connection between the front of the transition section 5 and a front of the body lower portion. This design can prevent the left edge portion 3 at a left side of the body lower portion from pressing buttocks of a driver and a passenger for a long time during driving, thereby improving a comfort of the driver and passenger.

Referring to FIGS. 1 and 2, at least one support protrusion 6 is provided on a back of the body lower portion, thereby a large ventilation space is formed between a back of the cushion and a seat without installing a fan. This ventilation space can still ensure sufficient ventilation even without installing the fan, especially when the cushion is compressed by the driver or passenger when leaning on, a convection effect of air through the ventilation holes will be stronger; a recess 7 is provided at a front side of the body lower portion and a corresponding position of the support protrusion 6. In this embodiment, there are two support protrusions 6 arranged spaced apart. By providing with the recess 7 at the front side of the body lower portion and the corresponding position of the support protrusions 6, air can be better diffused towards the edge portion 3 after being obstructed, effectively improving the ventilation effect. And the recess 7 can reduce a manufacturing cost to a certain extent and save manufacturing materials.

The fan installation position 2 is located on a back of the body middle portion and close to the body lower portion. In this embodiment, the fan installation position 2 is located above the support protrusion 6, which can render the fan to be closer to the support protrusion 6 after being installed. Providing the fan installation position 2 near the support protrusion 6, even if the driver and passenger are leaning back, it will not cause the fan position to be too close to the seat and backs of the driver and passenger, thereby greatly improving a problem of reduced air output and obstructed air flow. If the fan is installed in the fan installation position, a ventilation effect will be stronger, more significant, and better.

In order to improve a comfort during driving, both the body upper portion and the body lower portion are inclined towards the body middle portion and towards the front of the cushion body; the body middle portion are bent from its upper and lower ends towards a middle and towards the front of the cushion body. At the same time, the body upper portion, the body middle portion, and the body lower portion are all provided with an arc-shaped transition surfaces on left and right sides from a middle. This design can better fit the waist and back of the driver and passenger during driving, thereby providing good support for the waist and back.

Referring to FIG. 1, the front of the cushion body is longitudinally provided with a plurality of guide grooves 8, all of which are extended from lowers of the body lower portion or/and the body middle portion to the edge portion 3 at uppers of the body upper portion and/or the body middle portion. In this embodiment, the guide groove 8 is extended from a lower of the body middle portion to the edge portion 3 at uppers of the body upper portion and the body middle portion, and the guide groove 8 is extended to the edge portion 3 and connected to the edge portion 3.

At the same time, referring to FIG. 2, the back of the cushion body and a corresponding position of each guide groove 8 are protruded towards the back of the cushion body to form a reinforcing rib 9. The reinforcing ribs 9 are all extended from lowers of the body lower portion or/and the body middle portion to uppers of the body upper portion and/or the body middle portion. In this embodiment, the reinforcing ribs 9 are all extended from a lower of the body upper portion to an upper of the body middle portion, and one end of the reinforcing rib 9 located at the uppers of the body upper portion and/or the body middle portion is not connected to the edge portion 3. The fan installation position 2 is provided on the reinforcing rib 9 on a lower of the body middle portion. In this embodiment, two adjacent reinforcing ribs 9 located in a middle are respectively provided with two positioning columns arranged at intervals, and the fan is installed and fixed through the positioning columns on the two reinforcing ribs 9.

In order to ensure that the cushion is not easily displaced due to an adjustment of a sitting posture of the driver and the passenger, a lower of the cushion body is connected to an elastic support member 10 that is inclined downward towards a rear direction. The elastic support member 10 is connected to the lower of the cushion body through an arc-shaped transition connector 11. In this embodiment, left and right edges of the elastic support member 10 are gradually contract and tilt towards a middle from the rear direction. This not only ensures that the elastic support member can be well inserted into a gap of the vehicle seat, but also effectively reduces material waste and saves costs without changing elastic support performances of the transition connection member 11 and the elastic support member 10 near the transition connection member 11.

The above are the preferred embodiments of the present application and do not limit the protection scope of the present application. Therefore, any equivalent changes made according to the structure, shape, and principle of the present application should be included in the protection scope of the present application.

What is claimed is:

1. A ventilated cushion for vehicle seats, comprising a cushion body, which is provided with a plurality of ventilation holes,
a back of the cushion body that is located in an area of the ventilation holes is provided with a fan installation position;
the cushion body comprises an edge portion and a body upper portion, a body middle portion, and a body lower portion arranged in sequence from top to bottom;
the body upper portion, the body middle portion, and the body lower portion are all located in an area surrounded by the edge portion;
a back of the body lower portion is provided with at least one support protrusion, and the fan installation position is located on a back of the body middle portion and close to the body lower portion.

2. The ventilated cushion for vehicle seats according to claim 1, wherein the body upper portion and the body lower portion both are faced towards the body middle portion and tilted towards a front of the cushion body;
the body middle portion is bent from its upper and lower ends towards a middle and towards the front of the cushion body.

3. The ventilated cushion for vehicle seats according to claim 1, wherein the body upper portion, the body middle portion, and the body lower portion are all provided with arc-shaped transition surfaces on left and right sides from a middle.

4. The ventilated cushion for vehicle seats according to claim 1, wherein the edge portions provided on left and right sides of the body middle portion are bent towards the front of the cushion body to form an arc-shaped support edge.

5. The ventilated cushion for vehicle seats according to claim 1, wherein a front of the edge portion is higher than fronts of the body upper portion, the body middle portion, and the body lower portion,
the edge portion is provided with transition sections at left and right sides of the body lower portion;
a front of the transition section is inclined towards the back of the cushion body to form a connection between the front of the transition section and the front of the body lower portion.

6. The ventilated cushion for vehicle seats according to claim 1, wherein a front of the cushion body is longitudinally provided with a plurality of guide grooves,
the guide grooves are all extended from lowers of the body lower portion and/or the body middle portion to the edge portions of uppers of the body upper portion and/or the body middle portion.

7. The ventilated cushion for vehicle seats according to claim 6, wherein the back of the cushion body and a corresponding position of each guide groove are protruded towards the back of the cushion body to form a reinforcing rib,
the reinforcing ribs are all extended from lowers of the body lower portion and/or the body middle portion to uppers of the body upper portion and/or the body middle portion,
one end of the reinforcing rib located at the uppers of the body upper portion and/or the body middle portion is not connected to the edge portion;
the fan installation position is provided on the reinforcing rib on a lower of the body middle portion.

8. The ventilated cushion for vehicle seats according to claim 1, wherein a recess is provided at a front of the body lower portion and a corresponding position of the support protrusion.

9. The ventilated cushion for vehicle seats according to claim 1, wherein a lower of the cushion body is connected to an elastic support member that is inclined downward towards a rear direction, and the elastic support member is connected to the lower of the cushion body through an arc-shaped transition connection member.

10. The ventilated cushion for vehicle seats according to claim 9, wherein left and right edges of the elastic support member are gradually contract and tilt towards a middle from the rear direction.
